(19) United States
(12) Patent Application Publication
(10) Pub. No.: US 2022/0188026 A1
(43) Pub. Date: Jun. 16, 2022

(54) DATA STORAGE APPARATUS AND OPERATION METHOD THEREOF

(71) Applicant: SK hynix Inc., Gyeonggi-do (KR)

(72) Inventor: Eun Soo JANG, Gyeonggi-do (KR)

(21) Appl. No.: 17/244,234

(22) Filed: Apr. 29, 2021

(30) Foreign Application Priority Data
Dec. 10, 2020 (KR) 10-2020-0172503

(51) Int. Cl. G06F 3/06

(52) U.S. Cl. CPC G06F 3/0659; G06F 3/0673; G06F 3/0656; G06F 3/0619

(57) ABSTRACT

A data storage apparatus may include: a storage comprising a memory cell array and configured to complete a program operation for the memory cell array by sequentially performing a first stage program operation and a second stage program operation, and output, after the first stage program operation, a partial program completion signal in response to a first program command for first data; and a controller configured to transmit the first program command to the storage, and invalidate the first data stored in a buffer memory and perform a preparation operation for a subsequent request, as the partial program completion signal is received from the storage. The storage performs the second stage program operation while the controller performs the preparation operation for the subsequent request.

### CROSS-REFERENCES TO RELATED APPLICATION

The present application claims priority under 35 U.S.C. § 119(a) to Korean application number 10-2020-0172503, filed on Dec. 10, 2020, which is incorporated herein by reference in its entirety.

### BACKGROUND

### 1. Technical Field

Various embodiments of the present disclosure generally relate to a semiconductor integrated apparatus, and more particularly, to a data storage apparatus and an operation method thereof.

### 2. Related Art

A data storage apparatus performs a data input/output operation according to a request of a host device, using a volatile or nonvolatile memory device as a storage medium.

The operating speed of the data storage apparatus may determine the performance of the entire system.

However, since the host device and the data storage apparatus have different operating speeds, it is difficult for the system to perform with maximum performance, when the different operating speeds are not overcome.

### SUMMARY

In an embodiment of the present disclosure, a data storage apparatus may include: a storage comprising a memory cell array and configured to complete a program operation for the memory cell array by sequentially performing a first stage program operation and a second stage program operation, and output, after the first stage program operation, a partial program completion signal in response to a first program command for first data; and a controller configured to transmit the first program command to the storage, and invalidate the first data stored in a buffer memory and perform a preparation operation for a subsequent request, as the partial program completion signal is received from the storage. The storage performs the second stage program operation while the controller performs the preparation operation for the subsequent request.

In an embodiment of the present disclosure, a data storage apparatus may include: a storage comprising a memory cell array and configured to complete a program operation for the memory cell array by performing a plurality of sub program cycles; and a controller configured to control, as a first program request for first data is transmitted from a host device, the storage to perform some of the plurality of sub program cycles for the first data and then to transmit a partial program completion signal, receive second data from a host device and buffer the received second data, when the partial program completion signal is received, and control the storage to perform remaining sub program cycles other than the some of the sub program cycles for the first data while the second data is buffered.

In an embodiment of the present disclosure, there is provided an operation method of a data storage apparatus which includes: a storage comprising a memory cell array and configured to complete a program operation for the memory cell array by sequentially performing a first stage program operation and a second stage program operation; and a controller configured to control the storage. The operation method comprising transmitting, by the controller, a first program command for first data to the storage; performing, by the controller, a preparation operation for a subsequent request as the storage transmits a partial program completion signal to the controller in response to the first program command after the first stage program operation; and controlling, by the controller, the storage to perform the second stage program operation during the preparation operation.

In an embodiment of the present disclosure, there is provided an operation method of controller may comprises controlling a nonvolatile storage to perform a first operation of programming data therein in response to a first request, the first operation being configured by first and second stages; responding to the first request upon completion of the first stage; and controlling, upon completion of the second stage, the storage to perform a second operation in response to a second request arrived between the completion of the first and second stages, wherein the responding causes the second request.

### BRIEF DESCRIPTION OF THE DRAWINGS

FIG. 1 is a configuration diagram illustrating a data storage apparatus in accordance with an embodiment of the present disclosure.

FIG. 2 is a configuration diagram illustrating a controller in accordance with an embodiment of the present disclosure.

FIG. 3 is a configuration diagram illustrating a write request processing component in accordance with an embodiment of the present disclosure.

FIG. 4 is a conceptual view for describing a program operation in accordance with an embodiment of the present disclosure.

FIG. 5 is a flowchart illustrating an operation method of a data storage apparatus in accordance with an embodiment of the present disclosure.

FIG. 6 is a diagram for describing a sudden power off recovery (SPOR) concept in accordance with an embodiment of the present disclosure.

FIG. 7 is a configuration diagram illustrating a first program processing component in accordance with an embodiment of the present disclosure.

FIG. 8 is a diagram illustrating a data storage system in accordance with an embodiment of the present disclosure.

FIG. 9 and FIG. 10 are diagrams illustrating a data processing system in accordance with an embodiment of the present disclosure.

FIG. 11 is a diagram illustrating a network system including a data storage device in accordance with an embodiment of the present disclosure.

FIG. 12 is a block diagram illustrating a nonvolatile memory device included in a data storage device in accordance with an embodiment of the present disclosure.

### DETAILED DESCRIPTION

Hereinafter, a data storage apparatus and an operation method thereof according to the present disclosure will be described below with reference to the accompanying drawings through various embodiments.

FIG. 1 is a configuration diagram illustrating a data storage apparatus in accordance with an embodiment of the present disclosure.

Referring to FIG. 1, a data storage apparatus 10 in accordance with an embodiment may include a controller 110, a storage 120 and a buffer memory 130.

The controller 110 may control the storage 120 in response to a request of a host device (not illustrated). For example, the controller 110 may control the storage 120 to program data thereto according to a write request of the host device. Furthermore, the controller 110 may provide data, stored in the storage 120, to the host device in response to a read request of the host device.

The storage 120 may program data thereto or output data programmed therein, under control of the controller 110. The storage 120 may be configured as a volatile or nonvolatile memory device. In an embodiment, the storage 120 may be implemented as a memory device selected among various nonvolatile memory devices such as an EEPROM (Electrically Erasable and Programmable ROM), NAND flash memory, NOR flash memory, PRAM (Phase-Change RAM), ReRAM (Resistive RAM), FRAM (Ferroelectric RAM) and STT-MRAM (Spin Torque Transfer Magnetic RAM).

The storage 120 may include a plurality of nonvolatile memory devices (NVM) 121 to 12N, and each of the nonvolatile memory devices (NVM) 121 to 12N may include a plurality of dies, a plurality of chips or a plurality of packages. Furthermore, the storage 120 may be constituted by SLCs (Single-Level Cells) each capable of storing 1-bit data therein or XLCs (Extra-Level Cells) each capable of storing multi-bit data therein.

In an embodiment, the storage 120 may program data to a memory cell through a first stage program operation and a second stage program operation in response to a program command. When the controller 110 transmits a specially defined program command to the storage 120, the storage 120 may transmit a partial program completion signal to the controller 110 after completing the first stage program operation. The specially defined program command may be a command for increasing program speed, for example, a high-speed program command.

The storage 120 may also program data to a memory cell by performing sub program operations over a plurality of cycles in response to a program command. Each of the sub program operations may include a unit program operation and a verify operation. When the controller 110 transmits the high-speed program command to the storage 120, the storage 120 may perform some of the plurality of sub program cycles and then transmit a partial program completion signal to the controller 110.

In an embodiment, the storage 120 may be constituted by a plurality of memory blocks each including a plurality of pages, and group a plurality of pages by interleaving units to program data, under control of the controller 110.

The buffer memory 130 serves as a space capable of temporarily storing data which are transmitted/received when the data storage apparatus 10 performs a series of operations of writing or reading data while interworking with the host device. FIG. 1 illustrates the case in which the buffer memory 130 is positioned outside the controller 110. However, the buffer memory 130 may be provided inside the controller 110.

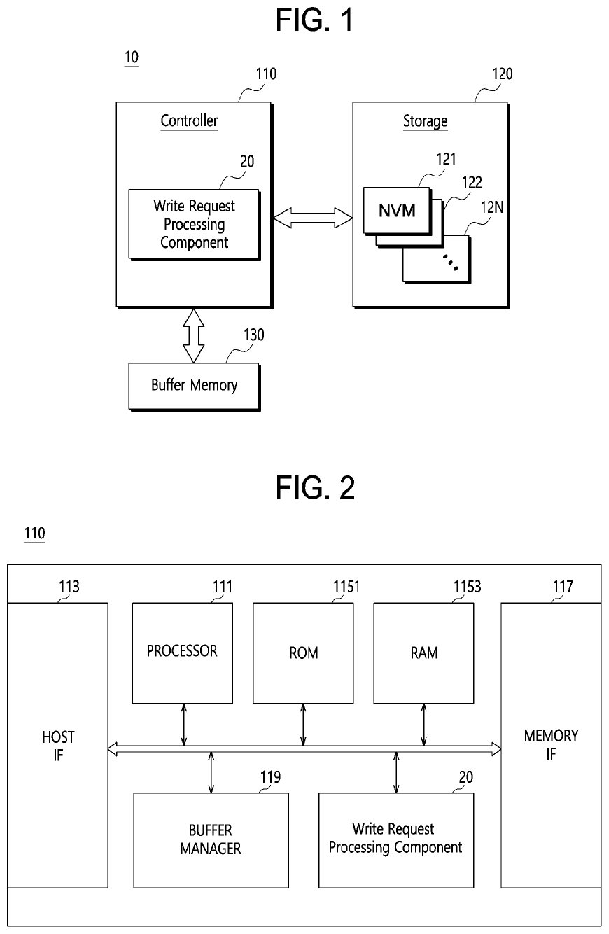

The buffer memory 130 may be controlled by a buffer manager (for example, buffer manager 119 of FIG. 2).

The buffer manager may divide the buffer memory 130 into a plurality of regions (slots), and allocate the respective regions to temporarily store data or release/invalidate the regions. When a region is allocated, it may indicate that data is stored in the corresponding region or data stored in the corresponding region is valid. When a region is released, it may indicate that no data is stored in the corresponding region or data stored in the corresponding region is invalidated.

The controller 110 may include a write request processing component 20.

The write request processing component 20 transmits a high-speed program command for storing first data to the storage 120 in response to a high-speed write request of the host device. Then, when the partial program completion signal is transmitted from the storage 120 after completion of the first stage program operation of storing the first data, the write request processing component 20 may perform a preparation operation for a subsequent request of the host device. For example, the write request processing component 20 may receive second data to be subsequently programmed and buffer the received second data into the buffer memory 130. During the preparation operation for the subsequent request, for example, while the second data is transmitted to the controller 110, the storage 120 may complete the program operation of storing the first data through a second stage program operation of storing the first data. That is, the second stage program operation for first data and the preparation operation for the subsequent request, for example, the buffering operation of the second data are processed in parallel, which makes it possible to improve the processing speed for the request of the host device.

The operation performed in parallel to the second stage program operation is not limited to the buffering operation of the second data and may include all operations which can be requested by the host device.

When the host device operates at higher speed than the data storage apparatus, the host device may become idle during the program operation of the data storage apparatus. In this case, resources may be wasted. In accordance with an embodiment of the present disclosure, however, the program time of the storage 120 and the subsequent operation of the host device may overlap each other, which makes it possible to improve the performance of a system to which the data storage apparatus 10 is applied.

FIG. 2 is a configuration diagram illustrating the controller in accordance with an embodiment of the present disclosure.

Referring to FIG. 2, the controller 110 in accordance with an embodiment may include a processor 111, a host interface 113, a ROM 1151, a RAM 1153, a memory interface 117, the buffer manager 119 and the write request processing component 20.

The processor 111 may be configured to transfer various pieces of control information to the host interface 113, the RAM 1153, the buffer manager 119 and the memory interface 117, the various pieces of control information being required for a data read or write operation for the storage 120. In an embodiment, the processor 111 may operate according to firmware which is provided for various operations of the data storage apparatus 10. In an embodiment, the processor 111 may perform functions of an FTL (Flash Translation Layer), such as garbage collection, address mapping and wear leveling, to manage the storage 120, or perform a function of detecting and correcting an error of data read from the storage 120.

The host interface 113 may receive a command and clock signal from the host device and provide a communication channel for controlling data input/output, under control of the processor 111. In particular, the host interface 113 may provide a physical connection between the host device and the data storage apparatus 10.

Furthermore, the host interface 113 may interface the data storage apparatus 10 in response to a bus format of the host device. The bus format of the host device may include one or more of standard interface protocols such as SD (Secure Digital), USB (Universal Serial Bus), MMC (Multi-Media Card), eMMC (embedded MMC), PCMCIA (Personal Computer Memory Card International Association), PATA (Parallel Advanced Technology Attachment), SATA (Serial Advanced Technology Attachment), SCSI (Small Computer System Interface), SAS (Serial Attached SCSI), PCI (Peripheral Component Interconnection), PCI-E (PCI Express) and UFS (Universal Flash Storage).

The ROM 1151 may store program codes required for an operation of the controller 110, for example, firmware or software, and code data used by the program codes.

The RAM 1153 may store data required for an operation of the controller 110 or data generated by the controller 110.

The memory interface 117 may provide a communication channel for transmitting/receiving signals between the controller 110 and the storage 120. The memory interface 117 may write data, temporarily stored in the buffer memory 130, to the storage 120 under control of the processor 111. Furthermore, the memory interface 117 may transfer data, read from the storage 120, to the buffer memory 130 to temporarily store the data.

The buffer manager 119 may be configured to manage the use state of each buffer memory 130. In an embodiment, the buffer manager 119 may divide the buffer memory 130 into a plurality of regions (slots), and allocate the respective regions to temporarily store data or invalidate data of the respective regions.

The write request processing component 20 may determine a write mode requested by the host device and transmit a command corresponding to the determination result to the storage 120, under control of the processor 111.

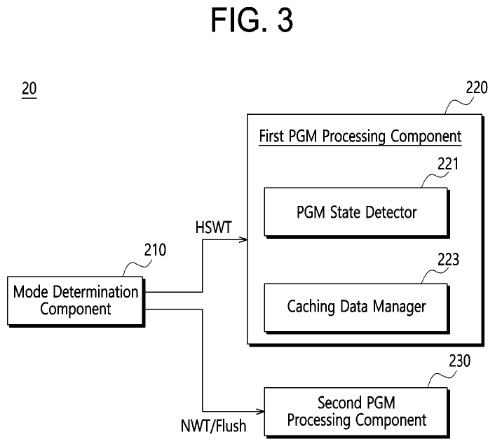

FIG. 3 is a configuration diagram illustrating the write request processing component 20 in accordance with an embodiment of the present disclosure.

Referring to FIG. 3, the write request processing component 20 in accordance with an embodiment may include a mode determination component 210, a first program processing component 220 and a second program processing component 230.

As the host device transmits a first write request and first write data, the first write data is buffered into the buffer memory 130. The first write request may be a high-speed write request for writing data at higher speed.

The mode determination component 210 may parse the request of the host device and determine whether the request is a first write request HSWT, a second write request NWT or a flush request Flush. A flush operation may indicate an operation of programming data, stored in the buffer memory 130, to the storage 120 according to the flush request. The second write request NWT may be a request for writing data at a different speed from the high-speed write request.

When the request of the host device is the first write request HSWT, the mode determination component 210 may control the first program processing component 220 to perform the request of the host device.

When the host device transmits the second write request NWT or the flush request Flush, the mode determination component 210 may control the second program processing component 230 to perform the request of the host device.

The first program processing component 220 may control the storage 120 to perform a high-speed program operation.

The high-speed program operation may indicate an operation in which the storage 120 performs the first stage program operation or some of a plurality of sub program cycles on a target memory cell, transmits the partial program completion signal to the controller 110 upon completion of the first stage program operation, and then performs the remaining program operation, for example, the second stage program operation or the other sub program cycles.

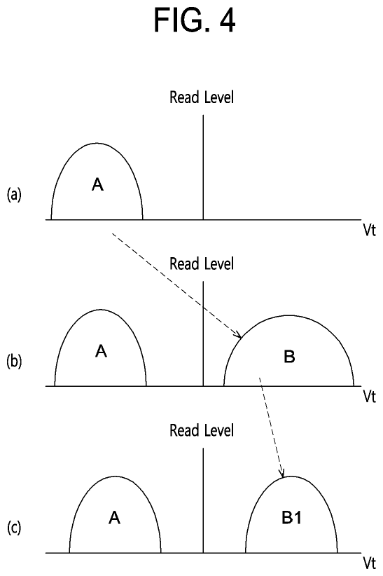

FIG. 4 is a conceptual view for describing the program operation in accordance with an embodiment of the present disclosure.

FIG. 4 illustrates a program operation of changing memory cells from a first state A to a second state B1. The storage 120 may change memory cells from the first state A into the preliminary second state B by performing the first stage program operation or some of the plurality of sub program cycles. Then, the storage 120 may additionally perform the second stage program operation or the other sub program cycles on the memory cells in the preliminary second state B and change the states of the corresponding memory cells to the second state B1.

The memory cells whose states are changed to the preliminary second state B by performing the first stage program operation or some of the plurality of sub program cycles may be read as the second state B1, when a read level is applied to read the memory cells. However, the storage 120 additionally performs the second stage program operation or the other sub program cycles to maintain the second state B1 despite a change in threshold voltage over time.

Referring back to FIG. 3, the first program processing component 220 may include a program state detector 221 and a caching data manager 223.

When the determination result of the mode determination component 210 indicates that a request of the host device is the high-speed write request HSWT, the first program processing component 220 may transmit the high-speed program command to the storage 120.

The program state detector 221 may receive the partial program completion signal for first write data from the storage 120, and transmit a response signal for the high-speed write request HSWT of the first data to the host device.

As the program state detector 221 receives the partial program completion signal for the first data, the caching data manager 223 may control the buffer manager 119 to invalidate the first write data stored in the buffer memory 130. Furthermore, when a second write request and second write data are transmitted from the host device, the caching data manager 223 may control the buffer manager 119 to store the second write request and the second write data in the buffer memory 130.

In accordance with an embodiment, when program-target memory cells are programmed to have the preliminary second state B1, the storage 120 transmits the partial program completion signal to the controller 110 to perform a preparation operation for a subsequent request. Furthermore, while the controller 110 performs the preparation operation for the subsequent request, for example, while the second write data is buffered into the buffer memory 130, the storage 120 performs the remaining program operation for the first write data. Therefore, it is possible to rapidly cope with a request of the host device, while guaranteeing the reliability of the program operation.

When the request of the host device is the second write request NWT or the flush request Flush, the second program processing component 230 may control the storage 120 to perform the second program operation, for example, a normal program operation having a different speed from the high-speed program operation.

The normal program operation may indicate an operation in which the storage 120 performs both of the first and second stage program operations or performs all of a preset number of sub program cycles, and then transmits a program completion signal to the controller 110.

When the program completion signal is received from the storage 120, the second program processing component 230 may transmit a response signal for the second write request NWT or the flush request Flush to the host device and receive the next request from the host device.

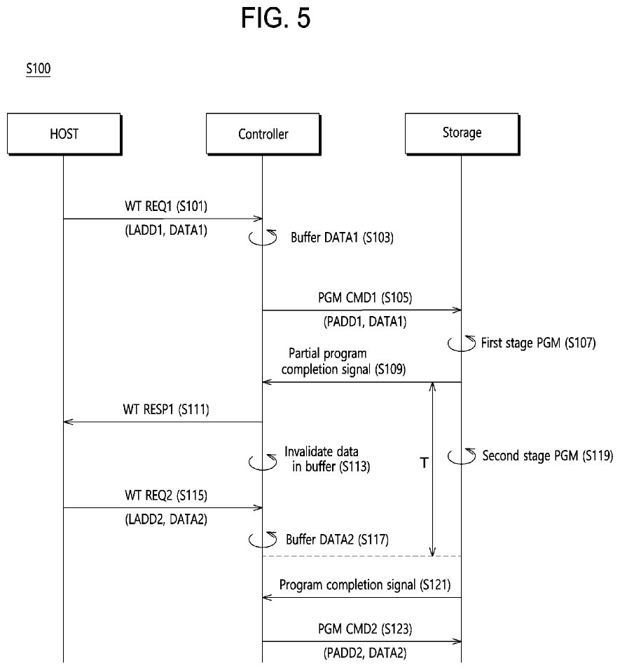

FIG. 5 is a flowchart illustrating an operation method of a data storage apparatus in accordance with an embodiment of the present disclosure.

Referring to FIG. 5, the case in which the host device transmits a first data write request for first data and then transmits a second data write request for second data will be described as an example.

As the host device transmits a first logical address LADD1 and first write data DATA1 with a first data write request WT REQ1 in operation S101, the first write data DATA1 is buffered into the buffer memory 130 in operation S103. Furthermore, the first logical address LADD1 may be translated into a first physical address PADD1.

When the first data write request WT REQ1 is determined to be a high-speed write request HSWT, the controller 110 may transmit the first physical address PADD1 and the first write data DATA1 to the storage 120 with a high-speed program command PGM CMD1 in operation S105.

Therefore, the storage 120 may perform a first stage program operation or some of a plurality of sub program cycles in operation S107 and transmit a partial program completion signal to the controller 110 in operation S109 upon completion of operation S107.

The controller 110 may transmit, to the host device, a response signal WT RESP1 for the high-speed write request HSWT for the first data in response to the partial program completion signal, in operation S111.

Furthermore, the controller 110 may control the buffer manager 119 to invalidate the first write data buffered in the buffer memory 130 in operation S113 and receive a second data write request WT REQ2 from the host device in operation S115. The second data write request WT REQ2 may include a second logical address LADD2 and second write data DATA2, and the controller 110 may store the second write data DATA2 in the buffer memory 130 in operation S117. After the second write data DATA2 is buffered, the second logical address LADD2 may be translated into a second physical address PADD2.

While the controller 110 buffers the second data in operation S117 after receiving the partial program completion signal in operation S109, the storage 120 may completely program the first data DATA1 by performing a second stage program operation for the first data DATA1 or the other sub program cycles, in operation S119.

As the storage 120 transmits a program completion signal to the controller 110 in operation S121 after the first data DATA1 is completely programmed, the controller 110 may transmit a second program command PGM CMD2 including the second physical address PADD2 and the second write data DATA2 to the storage 120 in operation S123.

In accordance with an embodiment, when the first write data is programmed in a preliminary state, namely the state B illustrated in FIG. 4, the storage 120 transmits the partial program completion signal to the controller 110 to perform a preparation operation for a subsequent request. Then, while the controller 110 performs the preparation operation for the subsequent request, the storage 120 may perform the remaining program operation for the first write data, thereby rapidly coping with the request of the host device.

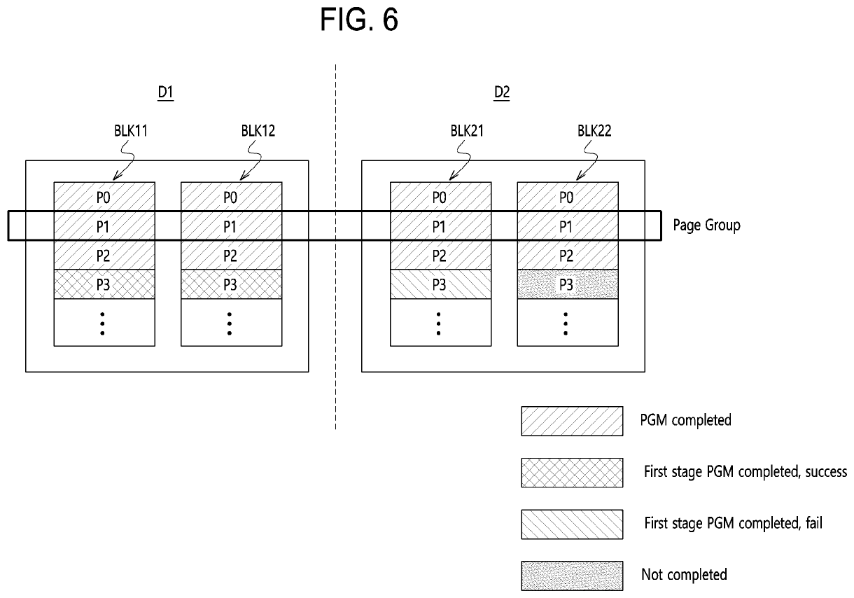

FIG. 6 is a diagram for describing a sudden power off recovery (SPOR) concept in accordance with an embodiment of the present disclosure.

The storage 120 may include one or more dies D1 and D2, and the dies D1 and D2 may include a plurality of memory blocks BLK11/BLK12 and a plurality of memory blocks BLK21/BLK22, respectively. Each of the memory blocks BLK11/BLK12 and BLK21/BLK22 may be constituted by a plurality of pages P0, P1, P1, P3, . . . .

In order to support an interleaving operation, pages having the same offset or different offsets within the plurality of memory blocks BLK11/BLK12 and BLK21/BLK22 may be grouped by interleaving units, thereby constituting a page group.

Program data may be sequentially programmed from the first page P0 group. While the data are programmed, a Sudden Power Off (SPO) may occur. The page group which was accessed for a program operation at the point in time when the SPO occurred may be referred to as the last access page.

When the data storage apparatus 10 is powered on after the SPO occurred, the controller 110 may perform a recovery operation. That is, the controller 110 generates a P2L list for valid pages of an open block on which a program operation was being performed, and stores the P2L list in an address mapping table.

Furthermore, when an operation interrupted by the SPO is a program operation, the controller 110 may check whether the program operation has been successfully performed, through a verify operation for the last access page, and then resume the program operation.

When an SPO occurs while a high-speed program operation is performed according to a page interleaving method, the last access page group may include a page for which the first stage program operation is completed and/or a page for which the first stage program operation is not completed. The page for which the first stage program operation is completed may succeed or fail in a verify read operation.

Since the program state of a memory cell for which only the first stage program operation has been performed is imperfect, it is desirable that data of the corresponding page is reprogrammed, even though a verify operation after the SPO indicates that the first stage program operation at the time of the SPO was successful.

Therefore, if the last access page group includes a page for which the first stage program operation is completed, when power is supplied again after an SPO, the controller 110 in accordance with an embodiment may reprogram data of the corresponding page group to another physical space.

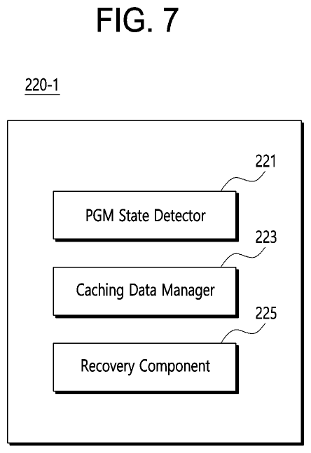

FIG. 7 is a configuration diagram illustrating a first program processing component in accordance with an embodiment of the present disclosure.

Referring to FIG. 7, the first program processing component 220-1 may include a program state detector 221, a caching data manager 223 and a recovery component 225.

The program state detector 221 and the caching data manager 223 may perform the functions which have been described above with reference to FIG. 3.

When an SPO occurs during a program operation and power is supplied again, the recovery component 225 may check the program state of a page group which has been accessed at the time of the SPO. When the last access page group includes a page for which the first stage program operation is completed and/or a page for which the first stage program operation is not completed, the recovery component 225 may reprogram data of the last access page group to another physical space, for example, another page group.

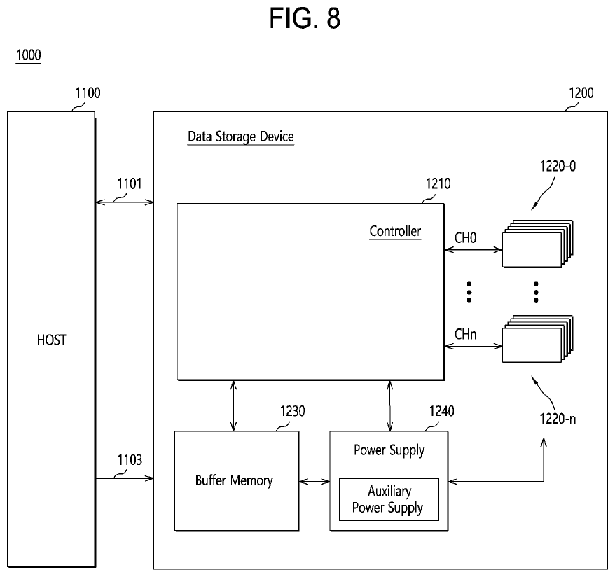

FIG. 8 is a diagram illustrating a data storage system 1000, in accordance with an embodiment of the present disclosure.

Referring to FIG. 8, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may be configured as controller 110 shown in FIGS. 1 to 3 and 7.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

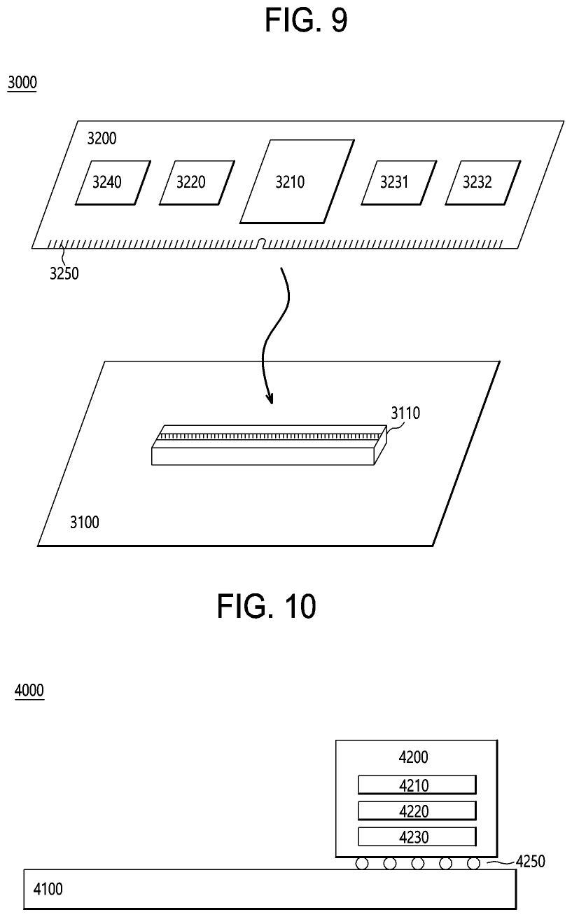

FIG. 9 is a diagram illustrating a data processing system 3000, in accordance with an embodiment of the present disclosure. Referring to FIG. 9, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 to 3 and 7.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 10 is a diagram illustrating a data processing system 4000 in accordance with an embodiment of the present disclosure. Referring to FIG. 10, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 to 3 and 7.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

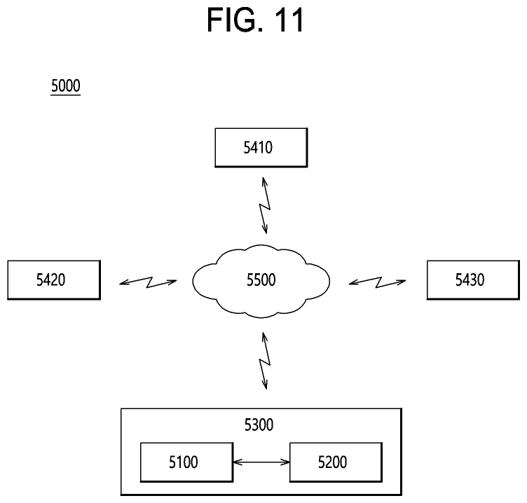

FIG. 11 is a diagram illustrating a network system 5000 including a data storage device, in accordance with an embodiment of the present disclosure. Referring to FIG. 11, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 8, the memory system 3200 shown in FIG. 9, or the memory system 4200 shown in FIG. 10.

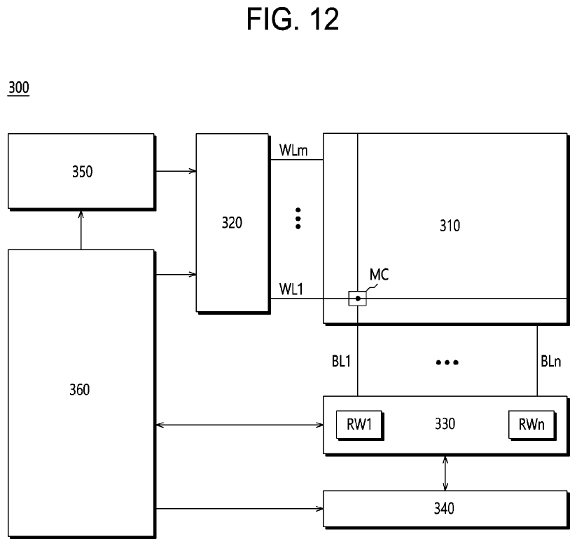

FIG. 12 is a block diagram illustrating a nonvolatile memory device 300 included in a data storage device, such as the data storage device 10, in accordance with an embodiment of the present disclosure. Referring to FIG. 12, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure in a perpendicular direction relative to the flat surface of a semiconductor substrate. Moreover, the three-dimensional memory array means a structure including NAND strings which memory cells comprised in NAND strings are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array memory cells are arranged in the horizontal and vertical directions with respect to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

While various embodiments have been described above, it will be understood to those skilled in the art that the embodiments described are examples only. Accordingly, the data storage apparatus and the operation method thereof, which have been described herein, should not be limited based on the described embodiments.

The above described embodiments of the present invention are intended to illustrate and not to limit the present invention. Various alternatives and equivalents are possible. The invention is not limited by the embodiments described herein. Nor is the invention limited to any specific type of data storage apparatus. Other additions, subtractions, or modifications which are apparent in view of the present disclosure are intended to fall within the scope of the appended claims.

What is claimed is:

1. A data storage apparatus comprising:
a storage comprising a memory cell array and configured to:
complete a program operation for the memory cell array by sequentially performing a first stage program operation and a second stage program operation, and
output, after the first stage program operation, a partial program completion signal in response to a first program command for first data; and
a controller configured to:
transmit the first program command to the storage, and
invalidate the first data stored in a buffer memory and perform a preparation operation for a subsequent request, as the partial program completion signal is received from the storage,
wherein the storage performs the second stage program operation while the controller performs the preparation operation for the subsequent request.

2. The data storage apparatus according to claim 1,
wherein the subsequent request is a program request for second data, and
wherein the preparation operation comprises an operation of receiving the second data from the controller and buffering the received second data into the buffer memory.

3. The data storage apparatus according to claim 1, wherein after a Sudden Power Off (SPO) occurs during the first stage program operation for the first data and power is supplied again, the controller is further configured to:
search for a last access page at a point in time when the SPO occurred,
store data, which is to be stored in the last access page, into another page regardless of whether data stored in the last access page was successfully programmed, and
resume the program operation for the first data on the another page.

4. The data storage apparatus according to claim 1,
is wherein the storage is constituted by a plurality of pages each configured to store data therein, and
wherein the controller is further configured to:
control the storage to group the plurality of pages by interleaving units to program data, and
after a SPO occurs during the program operation for a last access page group and power is supplied again, store data, which is to be stored in the last access page group, into another page group and resume the program operation for the first data on the another page group, when a page for which only the first stage program operation is completed is included in the last access page group.

5. The data storage apparatus according to claim 1,
wherein the controller is further configured to transmit a second program command or flush command to the storage, and
wherein the storage does not output the partial program completion signal in response to the second program command or the flush command, but is further configured to output a program completion signal after completing the first stage program operation and the second stage program operation.

6. A data storage apparatus comprising:
a storage comprising a memory cell array and configured to complete a program operation for the memory cell array by performing a plurality of sub program cycles; and
a controller configured to:
control, as a first program request for first data is transmitted from a host device, the storage to perform some of the plurality of sub program cycles for the first data and then to transmit a partial program completion signal,
receive second data from a host device and buffer the received second data, when the partial program completion signal is received, and
control the storage to perform remaining sub program cycles other than the some of the sub program cycles for the first data while the second data is buffered.

7. The data storage apparatus according to claim 6, wherein as the storage performs the remaining sub program cycles and then transmits a program completion signal upon completion of the sub program cycles for the first data, the controller is further configured to transmit a program command for the second data to the storage.

8. The data storage apparatus according to claim 6, wherein after a Sudden Power Off (SPO) occurs during the first stage program operation for the first data and power is supplied again, the controller is further configured to:
search for a last access page at a point in time when the SPO occurred,
store data, which is to be stored in the last access page, into another page regardless of whether data stored in the last access page was successfully programmed, and
resume the program operation for the first data on the another page.

9. The data storage apparatus according to claim 6,
wherein the storage is constituted by a plurality of pages each configured to store data therein, and
wherein the controller is further configured to:
control the storage to group the plurality of pages by interleaving units to program data, and
after a SPO occurs during the program operation for a last access page group and power is supplied again, store data, which is to be stored in the last access page group, into another page group and resume the program operation for the first data on the another page group, when a page for which only the first stage program operation is completed is included in the last access page group at a point in time when the SPO occurred.

10. The data storage apparatus of claim 6, wherein as a normal program request or flush request is transmitted from the host device, the controller controls the storage not to output the partial program completion signal in response to the second program command or flush command, but transmit the program completion signal after completing the first and second stage program operations.

11. An operation method of a data storage apparatus which comprises: a storage comprising a memory cell array and configured to complete a program operation for the memory cell array by sequentially performing a first stage program operation and a second stage program operation; and a controller configured to control the storage, the operation method comprising:
transmitting, by the controller, a first program command for first data to the storage;
performing, by the controller, a preparation operation for a subsequent request as the storage transmits a partial program completion signal to the controller in response to the first program command after the first stage program operation; and
controlling, by the controller, the storage to perform the second stage program operation during the preparation operation.

12. The operation method according to claim 11, wherein the preparation operation comprises an operation of invalidating the first data stored in a buffer memory.

13. The operation method according to claim 12,
wherein the subsequent request is a program request for second data, and
wherein the preparation operation comprises an operation of receiving the second data from the controller and buffering the received second data into the buffer memory.

14. The operation method according to claim 11, further comprising, after a Sudden Power Off (SPO) occurs during the first stage program operation for the first data and power is supplied again:
searching for, by the controller, a last access page at a point in time when the SPO occurred; and
storing, by the controller, data, which is to be stored in the last access page, into another page regardless of whether data stored in the last access page was successfully programmed.

15. The operation method according to claim 11,
wherein the storage is constituted by a plurality of pages each configured to store data therein, and
further comprising:
controlling, by the controller, the storage to group the plurality of pages by interleaving units to program data;
after a SPO occurs during the program operation for a last access program group and power is supplied again, searching for, by the controller, the last access page group; and
storing data, which is to be stored in the last access page group, into another page group, when a page on which only the first stage program operation is completed is included in the last access page group.

16. The operation method according to claim 11, further comprising:
transmitting, by the controller, a normal program command or flush command to the storage; and
controlling the storage not to transmit the partial program completion signal in response to the normal program command or flush command but transmit a program completion signal after completing the first and second stage program operations.

17. An operating method of a controller, the operating method comprising:
controlling a nonvolatile storage to perform a first operation of programming data therein in response to a first request, the first operation being configured by first and second stages;
responding to the first request upon completion of the first stage; and
controlling, upon completion of the second stage, the storage to perform a second operation in response to a second request arrived between the completion of the first and second stages,
wherein the responding causes the second request.

18. The operating method of claim 17,
wherein the storage includes a first group and a second group of pages,
wherein the first operation is an operation of programming the data into the first group, and
further comprising controlling, when a sudden power interruption occurs to the storage with the first operation incomplete, the storage to perform a third operation of programming the data into the second group.

19. The operating method of claim 17, further comprising, between the responding and the controlling of the storage to perform the second operation, preparing data for the storage to perform the second operation.

20. The operating method of claim 19, wherein the preparing includes invalidation data, which is related to the first operation, from an operational memory of the controller and buffering data, which is provided together with the second request and related to the second operation, in the operational memory.
